(19) United States
(12) Patent Application Publication
(10) Pub. No.: US 2008/0251505 A1
(43) Pub. Date: Oct. 16, 2008

(54) TrinityCorp RC-1

(75) Inventor: Charles Lee Henderson, Marietta, GA (US)

Correspondence Address: CHARLES L. HENDERSON, 1340 SEAN WAY, MARIETTA, GA, 30066, US

(73) Assignee: Charles Lee Henderson, Marietta, GA (US)

(21) Appl. No.: 11/501,333

(22) Filed: Apr. 12, 2007

(51) Int. Cl. B23K 26/38

(52) U.S. Cl. 219/121.67

(57) ABSTRACT

This tool is designed to make woodworking easy, quiet, precise and sanding free. The laser beam will cut to an exact depth with extremely fine cuts that are smooth and ready for joining or finishing. The entire process will use tiny amounts of energy, compared to conventional tools, and will replace a number of other tools currently in use.

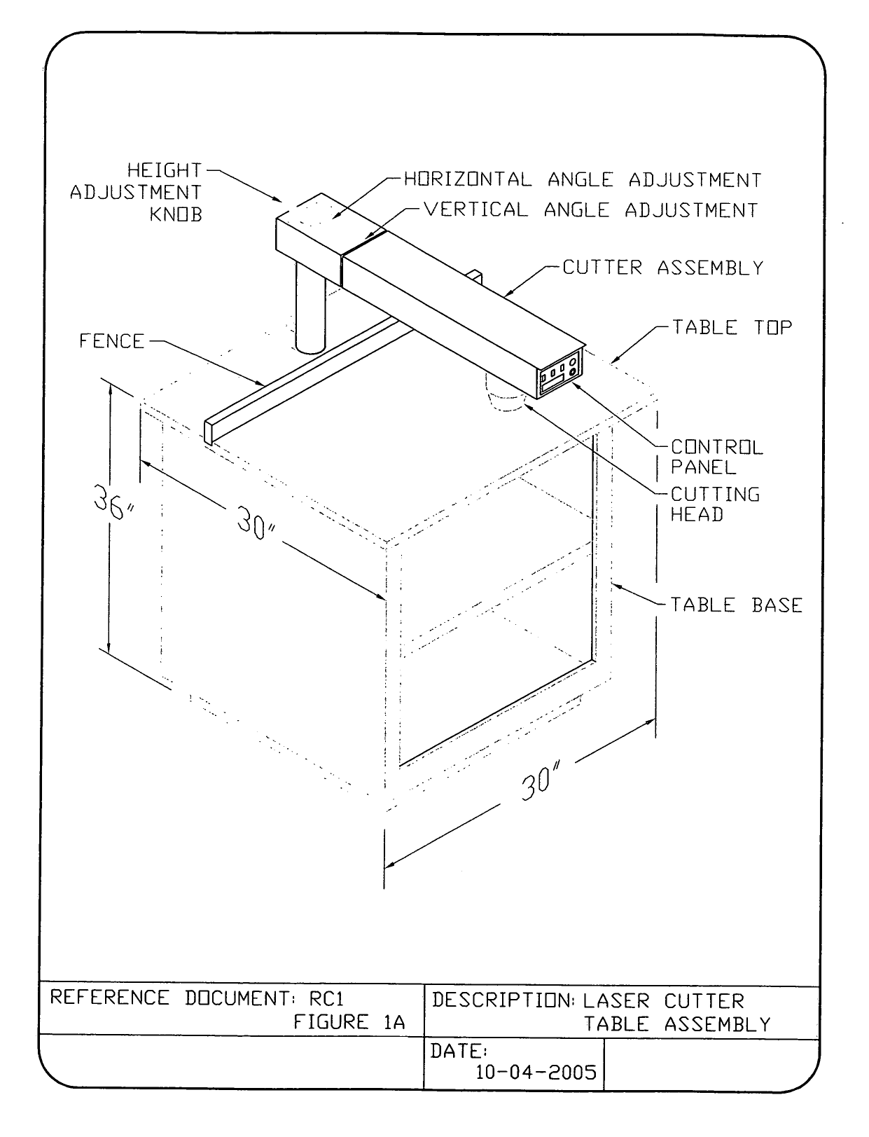

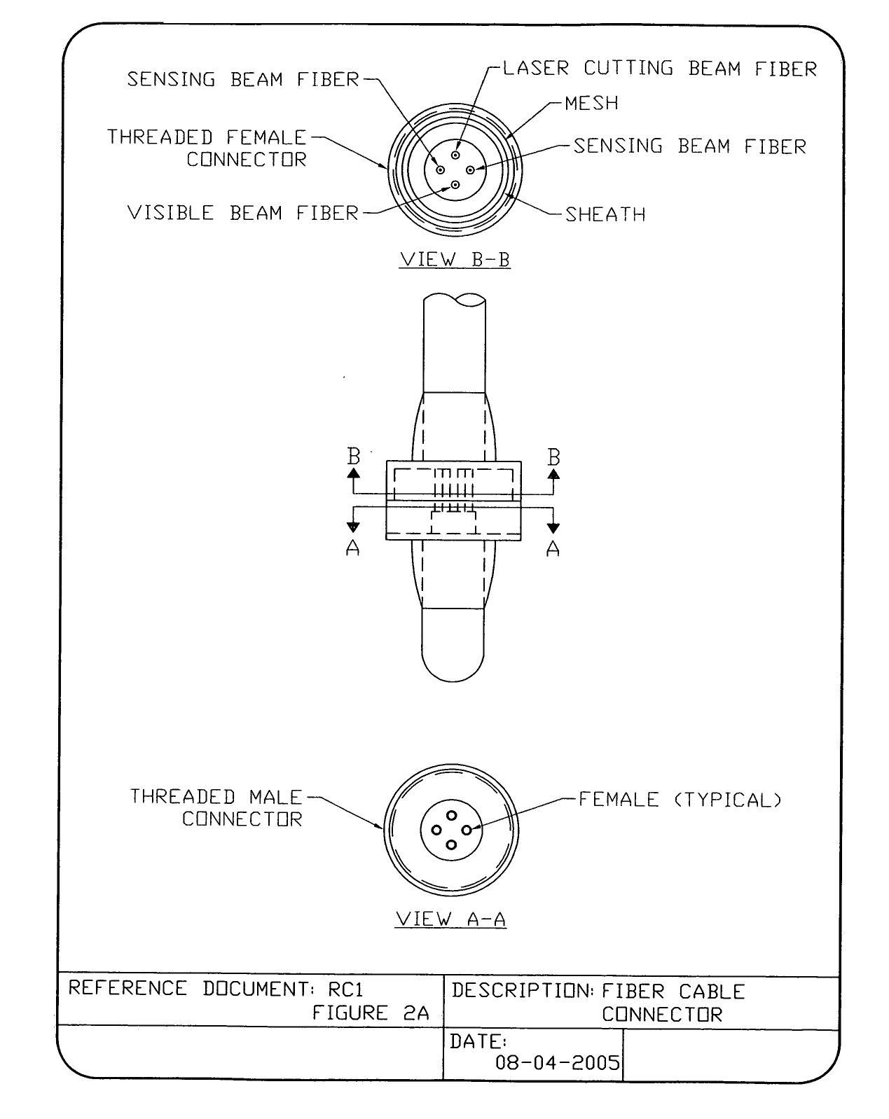

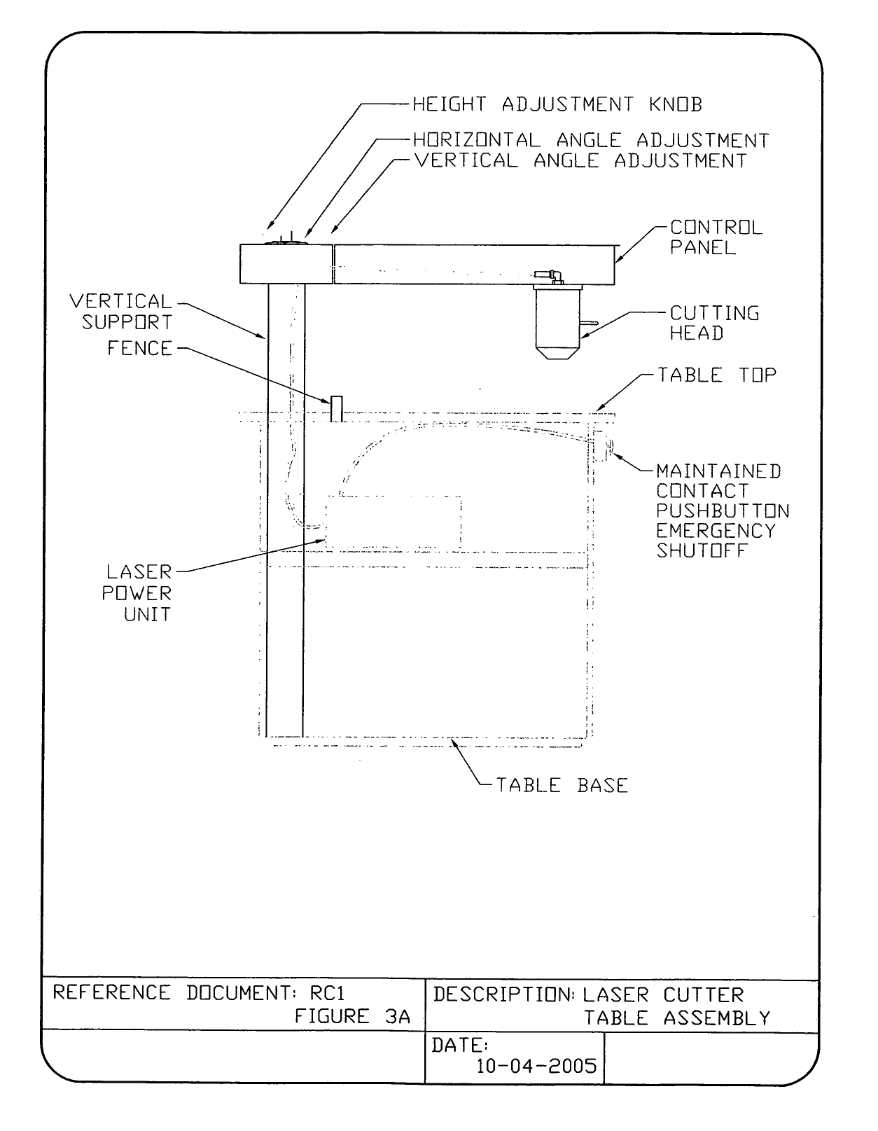

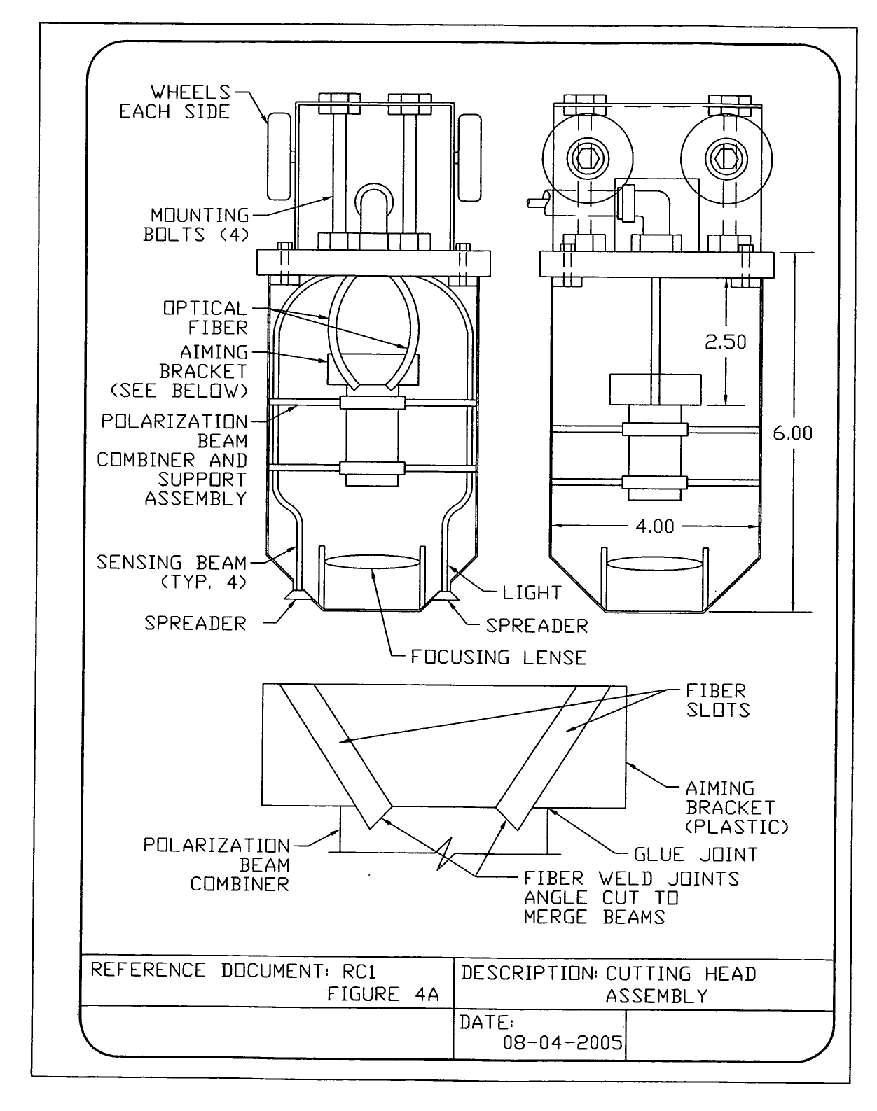

With no powered moving parts it will be safer than any other tool. The frequency adjustable sensors will make it safe for use in any environment for the skilled and unskilled person. Sensors will react only to flesh and instantly cut the power.

The parts, except for the head and table, are commercially available now. The use of combinations of these parts is the purpose of this invention.

### TOOL SPECIFICATIONS

Intent

These specifications are intended, in conjunction with the cabinet and tool drawings, to furnish the instructions for construction of the table, work surface, radial arm, cabinet and all attachments for the RC-1 radial cutting machine. This specification replaces all prior editions

Overview
Red Laser: Visible light for positioning
Invisible Laser: Cutting Beam
Depth of Cut: Maximum 9 inches; minimum 1/128 inch
Angle Adjustment: Maximum 60 degrees with stops at 30 degrees, 45 degrees and 60 degrees.
Safety: Four proximity switches turn power beam off; switches set to respond to frequency not reflected by flesh only. The proximity switches operate when the cutting beam is in the “ON” position.
See drawings for detailed dimensions
Laser is a standard Nd:YAG flash pumped solid state type or sealed gas CO₂ type with variable power output.

Operation General

Make sure all power switches are in “OFF” position; plug power cord into any 120VAC outlet. Raise or lower laser support arm, place stock on table and reposition bottom of laser cutting head one-quarter inch above stock. Set power switch in the “ON” position and set “depth of cut”. Set visible beam switch to “ON” position and place stock to exact position for cutting. Place the cutting beam switch to “ON” position. Move head to cut. If using the head as a jigsaw, lock head in desired position and move stock for pattern cut. Depth of cut is adjustable on the control keypad in increments of 1/128″. The keypad is an industrial membrane covered pad with ON/OFF for visible and power beam, UP/DOWN arrows for adjusting depth of cut. There is an emergency “KILL” switch with red mushroom head mounted on the right front below the table top to remove all power.

General

The cabinet shall be free standing with dimensions as shown on the drawings. The construction and wiring are to be in accordance with these specifications and applicable drawings.

The cabinet will be of the modified NEMA 1 type with louvered vents as required for cool circulation of air around the laser and power supply.

The laser, keypad, controller and multi-conductor/fiber cable will be supplied to the Fabricator for assembly. The Fabricator will be responsible for furnishing the remainder of parts.

Accessories and Components Included

Fabricator shall supply the following accessories and components:
All electrical wiring, terminal blocks (if used), springs, clamps, heat dissipation equipment, etc., required to provide a complete system.
All material for the cabinet, work surface (table), radial arm and casters (if ordered).
All sensors and emergency shutdown pushbutton.

Construction

Cabinets shall be of the conventional welded steel construction. Adequate framing shall be provided to ensure a rigid assembly.

Access doors shall be mounted on piano type hinges.

The cabinet, table top, fence, post, radial arm including all component parts shall be constructed and assembled in a thoroughly workmanlike manner. Particular attention shall be given to freedom from sharp edges, welding flaws, and proper installation of wiring.

Electrical Requirements

General

AC leads shall be grouped separately and kept segregated from the combination cable which includes the fiber optics cables. The power required will be 120VAC, 60 Hz.

Termination

All wiring shall be securely fastened using insulated ring type lugs

Grounding

Each laser enclosure shall have a copper ground lug mounted in the rear of the enclosure for ground connections.

Wire Type and Size.
Reference standard: National Fire Protection Association NFPA 70
   Electrical Standard for Industrial Equipment
Conductors shall not be smaller than specified:
Power wiring shall be No. 12 AWG, stranded copper, Type MTW.
Control circuits shall be No. 16 AWG, stranded copper, Type MTW.
Electronic control conductors shall not be smaller than No. 24 AWG, stranded copper, Type MTW.

Finish Requirements

Surface Preparation

Fabricated cabinet, post, radial arm and cutting head shall have all edges ground smooth, be sandblasted, and then cleaned with a solvent. Any voids shall be filled and ground smooth.

Priming

Immediately after cleaning, one coat of epoxy rust inhibiting primer compatible with finish paint shall be applied inside and outside. Clean primed surfaces and touch up with primer before applying finish coats on exterior. Exceptions will be granted for stainless steel enclosures and purchased enclosures.

Finish Painting

Cabinet Interior. Apply a minimum of two coats of flat white lacquer on the inside. Exceptions will be granted for stainless steel enclosures and purchased enclosures.

Cabinet Exterior. Finish coats shall be applied in a minimum of two (2) coats to equal a total of dry film thickness of 5 mils for finish coat and 7.5 mils minimum total dry film thickness for complete paint system, using an elcometer or equal.

Cutter Head and Laser General

Scope

The cutter head shall be precast aluminum made in two pieces with machine screw assembly with all necessary deformations required to house the beam combiner, the focusing lenses and the sensors. Screw type threads will be formed into the head for lens adjustment. Once adjusted, the threads will be intentionally burred to prevent movement. The beam combiner will be fixed in position. Alternatively, the beam combiner may be located in-line with the fiber and located within the cabinet housing.

The head will be assembled in such a way as to allow movement by hand directly to the head or the attachment of a preformed handle as the models change.

The head will be fixed in a mounting cradle at the top for fine adjustment of cutting angle with stops located at 30 degrees, 45 degrees and 60 degrees.

Within the head there will also be deformations for the mounting of the skin sensors.

Codes and Standards

All equipment shall meet applicable national standards for such apparatus including current standards of the American National Standards Institute (ANSI), Institute of Electrical and Electronics Engineers (IEEE), National Electrical Manufacturers Association (NEMA), National Electrical Code (NEC) and Underwriters' Laboratories, Inc. (UL), as applicable. Where UL “listed” or “labeled” components are available, they may be supplied.

The control equipment shall comply with NEMA Standard for Control Circuits and Control Devices.

### DESIGN REQUIREMENTS

The following general description applies to the adjustable power lasers covered by these specifications.

Control

The control equipment shall be supplied factory mounted, wired and tested within the enclosure. The controls shall be mounted within the radial arm with the front mounted keypad.

Laser

Scope

These specifications define the requirements for adjustable power lasers. While the equipment shall be supplied in conformance with these specifications, the laser vendor is not relieved of normal responsibility to supply well engineered, suitably constructed, and workable equipment within the framework of the specifications.

Equipment furnished shall be the manufacturer's latest standard design except where such standards appreciably deviate from these specifications.

Documents Referenced

The vendor shall completely comply with all applicable sections of the attached “Instructions to Bidders for Laser Equipment”.

Codes and Standards

All equipment shall meet applicable national standards for such apparatus including current standards of the-American National Standards Institute (ANSI), Institute of Electrical and Electronics Engineers (IEEE), National Electrical Manufacturers Association (NEMA), National Electrical Code (NEC) and Underwriters' Laboratories, Inc. (UL), as applicable. Where UL “listed” or “labeled” components are available, they may be supplied.

The control equipment shall comply with NEMA ICS-3-1988 (latest revision).

Power Control

The power control equipment shall be supplied, wired and tested in the following enclosure:

Floor mounted cabinet shall be free standing, self ventilated, NEMA Type I, steel enclosure. The cabinet shall be arranged for incoming power entry from the rear. The cabinet shall be suitable for mounting on casters and/or legs for the small cabinet. Cabinet ventilation shall be from the sides and rear.

An emergency shut-down switch shall be furnished and mounted on the front of the cabinet for quick removal of the power.

The controller shall be solid state, preprogrammed and mounted on the front of the radial arm. The controller shall have an industrial film type sealed keypad for adjusting the power for depth of cut control and the ON/OFF switching.

The operating power range shall be for cutting depth of 1/128″ thru 9″ in increments of 1/128″. The power adjustment will have a course and a fine adjustment for faster setup.

The following information shall be displayed on the front of the keypad. The keypad will have a two line led display to show the following:
Power “ON” indication
Cutting Beam “ON”
Cut Depth

All operator control devices shall be built in tact for installation by the assembler.

Paint Specifications

The system manufacturer's standard colors, finishing and painting system shall be used for the controllers covered by these specifications.

Testing

Each unit shall be tested by the assembler for satisfactory operation in each extreme setting prior to shipment.

Instruction Books

Instruction Books shall be provided with each unit and shall be complete documents covering the entire system and each component. Safety instructions will be furnished with the operators manual.

Detection System

General

This specification describes the requirements for Skin Detection. This specification outlines general performance and minimum requirements. It is not intended to design or patent anything which already exists on the open market.

This is primarily a functional specification. Functional requirements take precedence over hardware and software details contained herein, where there is a conflict concerning the equipment.

Codes and Standards

All equipment proposed and supplied shall meet applicable national standards for such apparatus, including the current standards of the American National Standards Institute (ANSI), the Institute of Electrical & Electronic Engineers (IEEE), the National Electrical Manufacturers Association (NEMA), the National Electrical Code (NEC), the National Electrical Safety Code (NESC), and Underwriters' Laboratories, Inc. (UL), as applicable.

It is intended that this equipment will be installed in complete accordance with the requirements of the latest edition of the National Electrical Code and the Williams-Steiger Occupational Safety & Health Act of 1970. The manufacturer's equipment design and construction shall be such that the installation can be easily made in compliance with said Act, without alteration or addition of internal circuitry or hardware.

Electrical and electronic equipment associated with the detector beam shall have a NEMA 1 rating. It should be noted at this point that the final exact shape of the cutter head will heavily depend on the shape and configuration of the skin detector being used.

Scope of Supply by Assembler

The skin detection system consists of, but is not limited to:
Housing
Sensing head assembly
Output circuitry
System power supply
Enclosures
Beam shutoff feature

Hardware and Sensor Functional Requirements
Power Supply. Normal power shall be 120VAC.
Redundancy. The components of the system shall not require redundancy.
Cables. All required interconnecting cables shall be provided complete with connectors.

Sensors
The following information (where applicable) for the sensors shall be supplied:
   Sensor model number and name
   Power and grounding requirements
   Principle of measurement
   Measurement range in terms of size classification
   Stability
   Frequency Response
   Dimensions of source, receiver and mounting frames
   Installation methods

What is claimed is:

1. An electrically powered cabinet mounted and enclosed power adjustable laser cutting tool. A laser, which is of the said tool which is of the Nd:YAG or CO₂ gas type laser which said laser is commercially available. Connecting fiber optical cable and copper wiring of said laser will connect the said laser to the cutting head of said tool to energize said tool for the cutting operation of said tool. The cabinet of said tool will enclose and support said laser for operation of said cutting head.

2. The power of said laser of claim 1, wherein power is adjustable, adjusted by keypad mounted on radial arm of said tool, radial arm which supports cutting head of said tool.

3. The power of said laser of claim 1, wherein power is adjustable, keypad of claim 2, will adjust said power through commercially available laser of claim 1, by enclosed microprocessor of said laser.

4. The keypad of claim 2, of said radial arm support, of said tool, will be mounted on front of said radial arm.

5. The cutting head of claim 1, will be adjustable in position on radial arm of said tool, for cutting of material placed on cabinet of said tool.

6. The cutting head of said tool of claim 1, will be mounted on radial arm of said tool, supported on said radial arm held in place on said radial arm by rollers inside said radial arm held in place by a lever mounted on said radial arm, pivoting on one end of said lever holding in place said tool cutting head.

7. The cutting head of said tool of claim 1, is made of formed aluminum or composite material of choice for said cutting head housing the optics of said cutting head of said tool.

8. The cutting head of claim 1, housing said optics of said cutting head is made of the mating parts for a combined single cutting head of said tool.

9. The cutting head of claim 1, will house the sensors of said tool mounted in said cutting head for safety of operation of said tool.

10. Sensors of claim 9, mounted in said cutting head are not part of claim of patent of said tool.

11. The cutting head of claim 7, housing the optics of said cutting head of said tool, optics of said cutting head will be adjustable for focus of said laser beam of claim 1.

12. The optics of claim 11, of said cutting head, will combine beams of said laser for aiming of said beam of said laser for cutting of material of claim 5. Aiming of beam of said laser by said cutting head of said tool will be adjustable of said cutting head of said tool radial arm.

13. The adjustable beam aiming of claim 12, will be adjustable by moving the said cutting head on the radial arm of said tool, rotating said cutting head on said radial arm of said tool about a pivoting point mounted on movable portion of cutting head for aiming of said beam of said laser.

14. Adjustable cutting head of claim 11, will be movable by hand about a pivoting point of said cutting head of said tool, for aiming of beam of said laser cutting head.

15. The laser of said tool of claim 1, will be powered by electrical current of alternating current source of 120 volts brought to said laser equipment by electrical power cord plugged into alternating current power receptacle.
